(19) United States
(12) Patent Application Publication
(10) Pub. No.: US 2026/0186798 A1
(43) Pub. Date: Jul. 2, 2026

(54) NONFUNGIBLE TOKEN DISPLAYED CONTENT

(71) Applicant: Hewlett-Packard Development Company, L.P., Spring, TX (US)

(72) Inventors: Alexander Williams, Spring, TX (US); Alexis Larrinaga, Spring, TX (US); Syed S. Azam, Spring, TX (US)

(73) Assignee: Hewlett-Packard Development Company, L.P., Spring, TX (US)

(21) Appl. No.: 19/123,182

(22) PCT Filed: Oct. 31, 2022
(86) PCT No.: PCT/US2022/048451

§ 371 Date: Apr. 22, 2025

(51) Int. Cl. G06F 9/451; G06F 21/10; G06F 21/16

(52) U.S. Cl. CPC G06F 9/451; G06F 21/1014; G06F 21/16

(57) ABSTRACT

In one example in accordance with the present disclosure, an image capturing device and monitor is described. The image capturing device includes a microcontroller, an imaging sensor, and a network controller communicatively coupled to the microcontroller to: (1) capture an image from a monitor; (2) extract a sub-image from the image; (3) determine whether a nonfungible token (NFT) corresponds with the sub-image; and (4) omit, responsive to the determining, the sub-image from a stored image.

### BACKGROUND

Electronic devices have become ubiquitous for creating and consuming digital content. In some cases, the content may be retrieved from a different system and displayed on an electronic device.

### BRIEF DESCRIPTION OF THE DRAWINGS

The accompanying drawings illustrate various examples of an devices and systems for protecting nonfungible token protected image data. The illustrated examples are given merely for illustration, and do not limit the scope of the claims.

FIG. 1 is a block diagram of a monitor to display NFT-protected image data, according to an example;

FIG. 2 is a block diagram of an image capturing device for displaying NFT-protected image data, according to an example; and

FIG. 3 is a block diagram of a system for displaying blocked NFT-protected image data, according to an example.

### DETAILED DESCRIPTION

NFT may be used as a digital representation of copyright ownership. It also may be utilized to indicate licensing arrangements between the copyright holder and licensees. Displays do not have implementations to query the blockchain of the associated NFT and determine whether an NFT may be recreated on that display based on the terms of the copyright license.

In some examples, A monitor may comprise a display panel, a network controller, and a microcontroller. The microcontroller may be communicatively coupled to the display panel and the network controller. The microcontroller may be configured to receive an input signal, where the input signal comprises a content corresponding to an NFT. The microcontroller may extract a content from the input signal. The microcontroller may render, responsive to the extraction, an overlay corresponding to the content associated with the NFT on the display panel.

In another example, an image capturing device may comprise an imaging sensor, a network controller, and a microcontroller. The microcontroller may be communicatively coupled to the imaging sensor and the network controller. The microcontroller may be configured to capture an image from a monitor. The microcontroller may extract a sub-image from the image. The microcontroller may determine whether a NFT corresponds with the sub-image, and omit, responsive to the determining, the sub-image from the stored image.

In another example, an NFT protection system comprises a monitor, and image capture device, and a blockchain ledger. The monitor of the NFT protection system may receive an input signal, wherein the input signal comprises a first content corresponding to an NFT. The monitor may extract the first content from the input signal. The monitor may display an overlay corresponding to the NFT on the display panel, responsive to the extraction. The image capturing device may capture a second content from the monitor. The image capturing device may extract an image from the second content. The imaging capturing device may determine whether an NFT corresponds with the image. The blockchain ledger of the NFT protection system may receive a query from the image capturing device corresponding to the image, where in the query comprises an identifier. The blockchain ledger may search a plurality of records comprising the identifier. The blockchain ledger may return the NFT corresponding to the identifier as a response to the query.

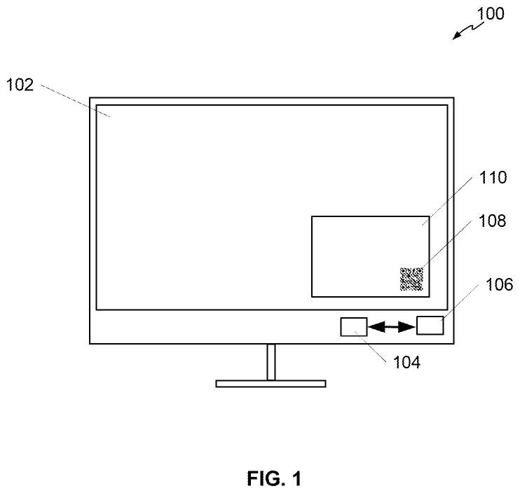

FIG. 1 is a block diagram of a monitor to display NFT protected image data, according to an example. The monitor 100 may include a display panel 102, and a microcontroller 106.

The monitor 100 generally refers to but is not limited to a self-contained display unit. The monitor 100 may include a housing to protect internal components. The monitor 100 may include a mounting mechanism including stands, or mounts to affix the monitor in spaces for easy use and display. The monitor 100 may be communicatively connected to an external computer system. In another implementation, a computer system may be inclusive to the housing of the monitor 100.

The monitor 100 may include a display panel 102. The display panel 102 may be affixed to the housing of the monitor and provides the a visual representation of data. The display panel 102 may be a liquid crystal display (LCD), organic light emitting diode (OLED), or other technology to recreate and display an image either actively with emissive display elements or passively with a backlighting system. A source driver and a gate driver may be inclusive to the display panel 102.

A network controller 104 may be internal to the housing of the monitor 100. The network controller 104 may support a wireless or wired networking interface. In some implementations, the network controller 104 may be a Bluetooth, Wi-Fi or cellular network adapter. In other implementations the network controller 104 may be an ethernet adapter. The network controller 104 facilitates the digital connectivity of the monitor 100, and any implementation that provides a connection to a network, either local, wide, or internet, may be used.

A microcontroller 106 may be communicatively coupled to the display panel 102 and the network controller 104. The microcontroller 106 may be an embedded application specific integrated circuit (ASIC) or a field programmable grid array (FPGA) component. The microcontroller 106 may include logic to provide scaler hardware functions including the rendering of onscreen displays (OSDs), and scaling of received images to resolutions compatible with the coupled display panel 102. The microcontroller 106 may include execution logic for executing programmable instructions. The microcontroller 106 may be a discrete processing unit, separate from an independent computer system. The microcontroller 106 may receive an input signal, wherein the input signal comprises a content. The input signal may correspond to a video stream from an independent computer system. The input signal may be input from an independent computer system via a wired transmission interface such as, but not limited to Display Port. In another implementation, the video stream may be received via wireless transmission via the network controller 104. The video stream may correspond to a rendered desktop imaging of an external computer system. The rendered desktop imaging may include visual representations of web browsers, digital photographic carousels, informational kiosk-style interfaces as well as other internet connected applications.

The microcontroller 106 may extract the content 110 from the input signal. The monitor 100 as described here may include the NFT identification features described in PCT Application PCT/US2022/034441 filed 22 Jun. 2022, entitled “DISPLAY OF NFT-PROTECTED IMAGE DATA” and incorporated by reference herein.

The microprocessor 106 may analyze individual frames from the video stream. The analyzation may include object detection and image segmentation to identify a content 110. The content may correspond to an NFT.

The microcontroller 106 may render, responsive to the extraction, an overlay 108 corresponding to the content 110 associated with the NFT on the display panel 102. The overlay may correspond to a frame around the content 110 associated with the NFT that is color coded for detection by an imaging sensor of an imaging capturing device. The overlay 108 may also correspond to a watermark or quick response (QR) code, as illustrated in FIG. 1. The watermark or QR code may be color coded for detection by an imaging capture device. In another implementation, the microcontroller 106 may adjust the rendering brightness of regions of the display panel 102 on a per frame basis that can be captured by an imaging device. The adjustment may include modulating the signal of the display panel 102 at a certain frequency. The brightness may encode information based on the sync of the display panel in conjunction with the brightness level.

In one implementation, the overlay 108 may have digital information encoded in a visual representation. In this implementation, QR code may be encoded with information pertaining to the NFT ID, the blockchain ledger identifier, as well as other identifying information. Other methods pertaining to the encoding of information in an overlay 108 may include pixel change encoding, as well as in blanking intervals. The overlay 108 may be adapted over the sub-image during motion video, where the sub-image moves do different locations on the display panel 102.

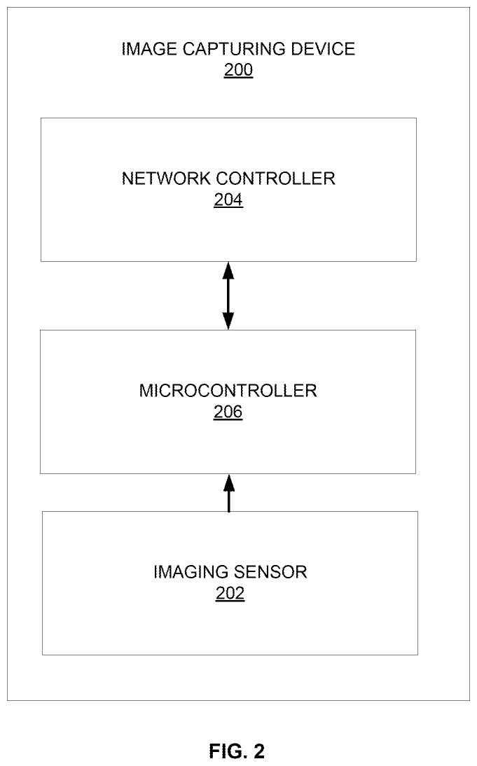

FIG. 2 is a block diagram of an image capturing device 200 for displaying NFT-protected image data, according to an example. In some implementations, the image capturing device 200 may correspond with a mobile computing device. More specifically, the image capturing device 200 may be a smartphone. The image capturing device 200 may include an imaging sensor 202, a microcontroller 206, and a network controller 204. The microcontroller 206 and network controller 204 may be of similar make as those described in reference to FIG. 1. However, the capturing device 200 may be a standalone device separate from the monitor 100 described in FIG. 1. The image capturing device 200 may include an imaging sensor 202. The imaging sensor 202 may be charge-coupled device (CCD), active-pixel sensor (CMOS), or any other digital image capturing sensor technology. The imaging sensor 202 may be communicatively coupled to the microcontroller 206. The imaging sensor 202 transfer a captured image to the microcontroller 206 for further processing. In some implementations the microcontroller 206 may have communicatively coupled memory logic (not shown) to store an image for processing by the microcontroller.

The microcontroller 206 may be communicatively coupled to the imaging sensor 202 and the network controller 204. The microcontroller 206 may capture an image from a monitor. The microcontroller 206 may capture an image from a monitor via signaling an instruction to the imaging sensor 202 to capture the image, and transfer the captured image to the microcontroller 206.

The microcontroller 206 may extract a sub-image from the image. The sub-image may correspond to a digitally captured representation of the content 110 as described in reference to FIG. 1. The microcontroller 206 may segment the image to identify a sub-image from the image. In some implementations, the segmentation may be keyed based on a fiducial mark within the image. The fiducial mark may correspond to the overlay 108 as described in relation to FIG. 1. The fiducial mark may be associated with an object captured within the image and located in an image segment as part of a sub-image. The fiducial mark may correspond to an overlay rendered in accordance with the description of FIG. 1. The sub-image may correspond to a digital representation of an NFT associated digital object (e.g. photograph of a photograph displayed on a monitor).

The microcontroller 206 may determine whether an NFT corresponds with the sub-image. The microcontroller 26 may extract any encoded information from an sub-image that may correspond to an overlay. Encoded information in the overlay may provide NFT identifier, blockchain ledger identifier, as well as other identifying information. The microcontroller 206 may connect using the network controller to interface with a blockchain ledger. The encoded information may provide the microcontroller 206 the corresponding blockchain for the NFT. The microcontroller 206 may utilize an NFT ID to look up digital right entitlements corresponding to the NFT. The microcontroller 206 may determine whether a cryptographic wallet associated with the image capturing device is authorized to use the sub-image.

The microcontroller 206 may omit, responsive to the determining the sub-image from a stored image. The microcontroller 206 may verify the cryptographic wallet's permissions against the blockchain ledger. The microprocessor 206 may either allow or block the sub-image from being displayed. The microprocessor 206 may validate the NFT has viewing entitlements on the blockchain implementation and present the image and sub-image unmodified. In the event that the viewing entitlement is not present or is explicitly prevented, the microcontroller may modify the frame prior to passing it to any image preview of the imaging capture device. In another implementation, the microcontroller 206 may update the image and sub-image from storing the unmodified image. In this example, the microcontroller 206 may mask the sub-image and present it to storage as a censored item (e.g. blacked out). In yet another implementation, the microcontroller 206 may not store the image and sub-image at all.

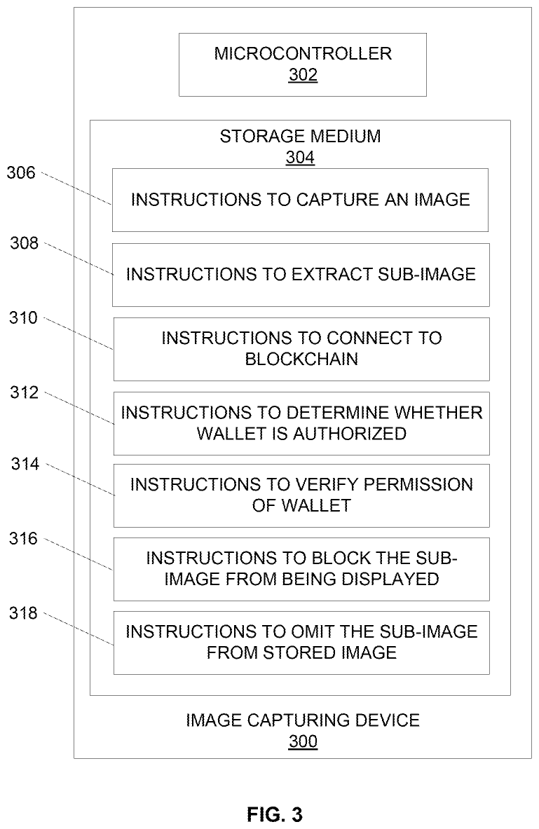

FIG. 3 is a block diagram of an image capturing device for displaying blocked NFT-protected image data, according to an example. The image capturing device 300 may be implemented in a similar manner to the image capturing device 200 as described in reference to FIG. 2. The image capturing device 300 depicts a microcontroller 302 and a storage medium 304 and, as an example of the image capturing device 300 performing its operations, the storage medium 304 may include instructions 306-318 that are executable by the microcontroller 302. The microcontroller 302 may be synonymous with the microcontroller 206 referenced in FIG. 2. Additionally, the microcontroller 206 may include but is not limited to central processing units (CPUs) as found in handheld mobile computing devices. The storage medium 304 can be said to store program instructions that, when executed by microcontroller 302, implement the components of the image capturing device 300.

The executable program instructions stored in the storage medium 304 include, as an example, instructions to capture an image from a monitor 306, instruction to extract a sub-image from the image 308, instructions to connect, using a network controller, to a blockchain ledger 310, instructions to determine whether a cryptographic wallet is authorized to use the sub-image 312, instructions to verify permissions of the cryptographic wallet against the blockchain ledger 314, instructions to block, responsive to the determination, the sub-image from being displayed 316, and instructions to omit, responsive to the determining, the sub-image from a stored image 318.

Storage medium 304 represents generally any number of memory components capable of storing instructions that can be executed by microcontroller 302. Storage medium 304 is non-transitory in the sense that it does not encompass a transitory signal but instead is made up of at least one memory component configured to store the relevant instructions. As a result, the storage medium 304 may be a non-transitory computer-readable storage medium. Storage medium 304 may be implemented in a single device or distributed across devices. Likewise, microprocessor 302 represents any number of processors capable of executing instructions stored by storage medium 304. Microcontroller 302 may be integrated in a single device or distributed across devices. Further, storage medium 304 may be fully or partially integrated in the same device as microcontroller 302, or it may be separate but accessible to that image capturing device 300 and the microcontroller 302.

In one example, the program instructions 306-318 may be part of an installation package that, when installed, can be executed by microcontroller 302 to implement the components of the image capturing device 300. In this case, storage medium 304 may be a portable medium such as a CD, DVD, or flash drive, or a memory maintained by a server from which the installation package can be downloaded and installed. In another example, the program instructions may be part of an application or applications already installed. Here, storage medium 304 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A monitor, comprising:
a display panel;
a network controller;
a microcontroller, communicatively coupled to the display panel and the network controller configured to:
receive an input signal, wherein the input signal comprises a content, corresponding to a nonfungible token (NFT);
extract the content from the input signal;
renders, responsive to the extraction, an overlay corresponding to the content associated with the NFT on the display panel.

2. The monitor of claim 1, wherein the overlay comprises a frame around the content associated with the NFT.

3. The monitor of claim 2, wherein the frame is color-coded for detection by an imaging device.

4. The monitor of claim 1, wherein the overlay comprises a watermark over the content associated with the NFT, and the watermark is color-coded for detection by an imaging device.

5. The monitor of claim 1, wherein the overlay comprises a QR code over the content associated with the NFT, and the QR code is coded for detection by an imaging device.

6. The monitor of claim 1, wherein a setting on the display panel toggles adjusted regions of brightness per frame, wherein the toggle adjusts regions of brightness within the display for detection by the imaging device.

7. An image capturing device comprising:
an imaging sensor;
a network controller;
a microcontroller, communicatively coupled to the imaging sensor and the network controller, and configured to:
capture an image from a monitor;
extract a sub-image from the image;
determine whether a nonfungible token (NFT) corresponds with the sub-image; and
omit, responsive to the determining, the sub-image from a stored image.

8. The image capturing device of claim 7, the microcontroller further configured to:
connect, using the network controller, to a blockchain ledger;
determine whether a cryptographic wallet is authorized to use the sub-image.

9. The imaging capturing device of claim 8, the microcontroller further configured to:
verify permissions of the cryptographic wallet against the blockchain ledger; and
block, responsive to the determination, the sub-image from being displayed.

10. The imaging capturing device of claim 8, wherein the blocking the sub-image from being displayed comprises masking the sub-image.

11. A non-transitory machine readable storage medium comprising instructions executable by a microcontroller to:
capture an image from a monitor;
extract a sub-image from the image;
connect, using a network controller, to a blockchain ledger;
determine whether a cryptographic wallet is authorized to use the sub-image;
verify permissions of the cryptographic wallet against the blockchain ledger;
block, responsive to the determination, the sub-image from being displayed; and
omit, responsive to the determining, the sub-image from a stored image.

12. The non-transitory machine readable storage medium of claim 11, wherein the instructions to block the sub-image from being displayed comprises instructions to mask the sub-image.

13. The non-transitory machine readable storage medium of claim 11, the instructions to extract the sub-image comprise instructions to extract encoded information in an overlay.

14. The non-transitory machine readable storge medium of claim 13, wherein the encoded information in the overlay comprises an NFT identifier and a blockchain ledger identifier.

15. The non-transitory machine readable storage medium of claim 14, wherein the overlay corresponds to adjusting regions of screen brightness on a per frame basis.
